(19) United States
(12) Patent Application Publication
(10) Pub. No.: US 2020/0349644 A1
(43) Pub. Date: Nov. 5, 2020

(54) SYSTEMS AND METHODS FOR AN INTERACTIVE MORTGAGE DASHBOARD

(71) Applicant: JPMORGAN CHASE BANK, N.A., New York, NY (US)

(72) Inventors: Jeffrey M. VANEK, St. Louis, MO (US); Veronica CHAPPLE, Lantana, TX (US)

(21) Appl. No.: 16/864,627

(22) Filed: May 1, 2020

Related U.S. Application Data
(60) Provisional application No. 62/842,594, filed on May 3, 2019.

(51) Int. Cl. G06Q 40/02; G06N 20/00

(52) U.S. Cl. CPC G06Q 40/025; G06N 20/00

(57) ABSTRACT

Systems and methods for an interactive mortgage dashboard are provided. A computer-implemented method for providing a mortgage finance dashboard may include: (1) retrieving loan transaction information for a plurality of loan accounts; (2) verifying that the loan transaction information complies with predetermined formatting requirements; (3) generating and displaying a summary table of the retrieved loan transaction information on a display, the summary table comprising one or more of customer names, advances, paydowns, deposits, shipments, and transfers for each loan account; (4) identifying a loan condition or trend associated with at least one of the loan accounts; (5) identifying a recommendation for the at least one of the loan accounts based on the loan condition or trend; (6) associating a graphical indicator with the loan condition or trend; (7) displaying the graphical indicator on the display with the recommendation; and (8) automatically executing the recommendation.

### RELATED APPLICATIONS

This application claims the benefit of, and priority to, U.S. Provisional Patent Application Ser. No. 62/842,594 filed May 3, 2019, the disclosure of which is hereby incorporated, by reference, in its entirety.

### BACKGROUND OF THE INVENTION

### 1. Field of the Invention

The present disclosure relates to systems and methods for an interactive mortgage dashboard, and more particularly to pulling together multi-channel streams of information succinctly in one place.

### 2. Description Of The Related Art

Financial institutions may deal with warehouse lending as part of a mortgage finance business. Warehouse lending may refer to a line of credit given to a loan originator to fund a mortgage. Warehouse lending may require a large staff to manage because it involves the handling of information between internal and external entities at every step of the process. The timeline from when a loan request is initiated by a customer to when a financial institution funds the loan is required to be processed within a strict service level agreement, or SLA. Software systems in place to support this process may be slow and complex, compounding the difficulties of warehouse lending.

Warehouse lending is highly competitive. Service level agreements with clients may specify that a loan transaction must be cleared within a certain amount of time. Due to the nature of the business, there is little friction for a client to take their business to another financial institution if the loan is taking too long. Slow processing times may lead to loss of business.

### SUMMARY OF THE INVENTION

Systems and methods for an interactive mortgage dashboard are provided. In an information processing apparatus comprising at least one computer processor, a computer-implemented method for providing a mortgage finance dashboard may include: (1) retrieving loan transaction information for a plurality of loan accounts; (2) verifying that the loan transaction information complies with predetermined formatting requirements; (3) generating and displaying a summary table of the retrieved loan transaction information on a display, the summary table comprising one or more of customer names, advances, paydowns, deposits, shipments, and transfers for each loan account; (4) identifying a loan condition or trend associated with at least one of the loan accounts; (5) identifying a recommendation for the at least one of the loan accounts based on the loan condition or trend; (6) associating a graphical indicator with the loan condition or trend; (7) displaying the graphical indicator on the display with the recommendation; and (8) automatically executing the recommendation.

In one embodiment, the recommendation may be a haircut, to recalculate a loan, to contact the loan account holder, etc.

In one embodiment, the method may further include automatically re-formatting the loan transaction information to comply with the predetermined formatting requirements.

In one embodiment, wherein the loan condition or trend associated with the at least one of the loan accounts may be identified based on historical loan information for the at least one of the loan accounts, using machine learning, etc.

In one embodiment, the graphical indicator may be an icon and/or a color.

In one embodiment, the recommendation may be automatically executed in response to a selection of the graphical indicator.

According to another embodiment, a system for providing a mortgage finance dashboard may include: an electronic device comprising at least one computer processor and executing a mortgage finance dashboard computer program; a plurality of internal data sources storing internal loan information for a plurality of customers; and plurality of third-party data sources storing external loan information for at least some of the plurality of customers.

The mortgage finance dashboard computer program may retrieve loan transaction information for a plurality of loan accounts from the internal data sources and the external data sources; may verify that the loan transaction information complies with predetermined formatting requirements; may generate and display a summary table of the retrieved loan transaction information on a display, the summary table comprising one or more of customer names, advances, paydowns, deposits, shipments, and transfers for each loan account; may identify a loan condition or trend associated with at least one of the loan accounts; may identify a recommendation for the at least one of the loan accounts based on the loan condition or trend; may associate a graphical indicator with the loan condition or trend; may display the graphical indicator on the display with the recommendation; and may automatically execute the recommendation.

In one embodiment, the recommendation may be a haircut, to recalculate a loan, to contact the loan account holder, etc.

In one embodiment, the mortgage finance dashboard computer program may automatically re-format the loan transaction information to comply with the predetermined formatting requirements.

In one embodiment, the loan condition or trend associated with the at least one of the loan accounts may be identified based on historical loan information for the at least one of the loan accounts, using machine learning, etc.

In one embodiment, the graphical indicator may be an icon and/or a color.

In one embodiment, the recommendation may be automatically executed in response to a selection of the graphical indicator.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for an interactive mortgage dashboard according to an exemplary embodiment.

FIG. 2 depicts exemplary graphical user interface elements for an interactive mortgage dashboard according to an exemplary embodiment.

FIG. 3 depicts exemplary graphical user interface elements for an interactive mortgage dashboard according to an exemplary embodiment.

FIG. 4 depicts exemplary graphical user interface elements for an interactive mortgage dashboard according to an exemplary embodiment.

FIG. 5 depicts an exemplary account reconciliation graphical user interface for an interactive mortgage dashboard according to an exemplary embodiment.

FIG. 6 depicts an exemplary “haircut” graphical user interface for an interactive mortgage dashboard according to an exemplary embodiment.

FIG. 7 depicts a method for providing a mortgage finance dashboard according to an exemplary embodiment.

### DETAILED DESCRIPTION OF PREFERRED EMBODIMENTS

Exemplary embodiments will now be described in order to illustrate various features. The embodiments described herein are not intended to be limiting as to the scope, but rather are intended to provide examples of the components, use, and operation of the invention.

Embodiments are directed to an interactive mortgage dashboard that automatically pulls together multi-channel streams of information succinctly in one place and that automatically processes such information to take action and generate alerts, such that warehouse lending can be processed faster and with fewer staff members.

According to certain embodiments, an interactive dashboard may be generated on a computing device executing an interactive dashboard program or application that may pull together multi-channel streams of information and display the information succinctly, such that the streams of data may be viewed all in one place. Third party information may be harnessed and rendered to be viewed in a dashboard alongside other internal indicators specific to a business, such that users may be able to visit one place to see indications of what to do next.

According to certain embodiments, users may be able to view mortgage entities, loan requests, payment information, and collateral all in real-time, or substantially in real-time. In one embodiment, this real-time information may include automatic refresh capabilities, automatic processing capabilities, and automatic alert-generation capabilities.

According to certain embodiments, the dashboard may use indicators to allow the dashboard to illustrate whether a loan is dry or wet. A dry loan may be, for example, a type of mortgage in which the loan funds have been advanced and the Note has been received by the Financial Institution. A wet loan may be, for example, a type of mortgage in which loan funds have been advanced and Financial Institution is pending receipt of the Note from customer. In one embodiment, the dry or wet status of a loan may be indicated by a rain drop indicator next to a specific loan request.

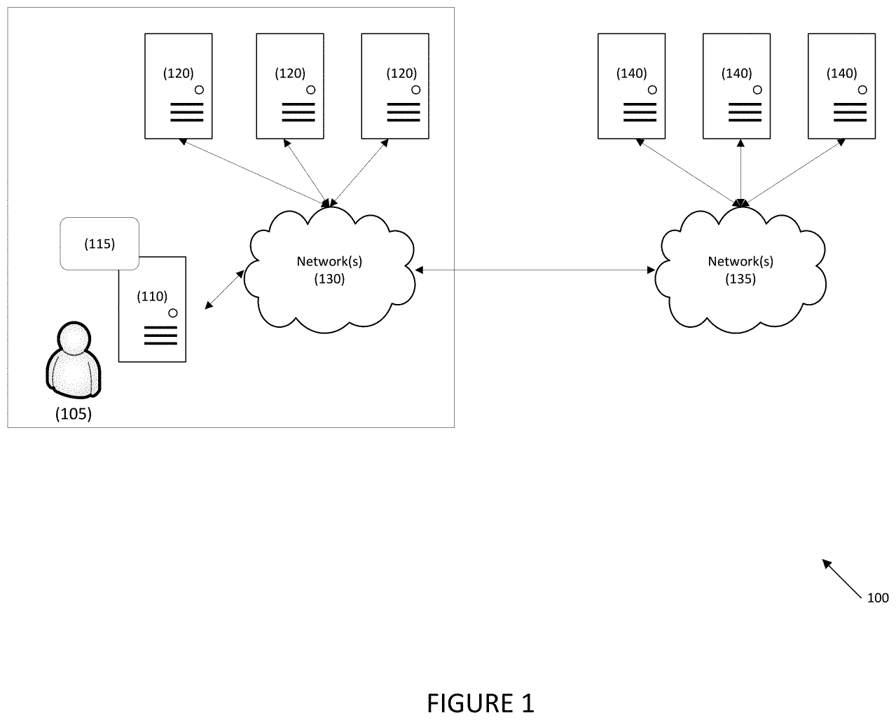

FIG. 1 is a diagram of a system for an interactive mortgage dashboard according to an exemplary embodiment of the invention.

As shown in FIG. 1, system 100 may include computing device 110 associated with user 105 that executes a mortgage finance dashboard program or application (not shown). For example, system 100 may be operated by a business or other type of organization that manages mortgages, mortgage funds, or other kinds of loans and funds.

System 100 may include one or more computing devices or data sources 120 that store information on clients, loan applications, existing loans, loan payments, etc. Computing devices/data sources 120 may store, for example, loan information from one or more client-facing websites.

System 100 may also include one or more third party computing devices or data sources 140 that store information clients, loan applications, existing loans, loan payments, etc.

System 100 may also include one or more networks 130 and 135 as part of a network that connect computing devices 110 and 120. The networks may comprise, for example, any one or more of the Internet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, or other network, for example.

In one embodiment, the one or more networks 130 form an intranet in which computing devices 110 and 120 are connected. Networks 135 may be external to networks 130 and may connect computing devices 110 and 120 to external computing devices 140.

Computing device 110 may execute mortgage finance dashboard program or application 115 that may retrieve information from computing devices 110 and/or computing devices 120, such as client loan documents. Mortgage finance dashboard program or application 115 may format the client loan documents and extract client loan information into directories on computing device 110. Mortgage finance dashboard program or application 115 may then load the client loan information into a mortgage finance dashboard user interface (not shown).

In one embodiment, the mortgage finance dashboard UI may track certain loan conditions and recommend action via an alert, for example, an action such as a haircut. As used herein, a haircut refers to a reduction of the warehouse advanced amount. A haircut may be recommended when the lender has not received the note by the negotiated time as defined on the credit agreement or based on other agreed upon terms in the credit agreement.

In one embodiment, the mortgage finance dashboard UI may display alerts as UI elements, for example a scissors (or similar) icon for a loan in which a haircut is recommended. The mortgage finance dashboard UI may also display UI elements next to loans that represent conditions being met, such as a rain drop (or similar) icon for a loan that is wet.

In embodiments, mortgage finance dashboard program or application 115 may use machine learning and/or artificial intelligence to identify certain loan conditions and/or actions to take in response to the certain loan conditions. This may include during an approval process, in which mortgage finance dashboard program or application 115 or a backend may be trained on historic data so that the approval process may be fully automated.

In one embodiment, mortgage finance dashboard program or application 115 may load new up-to-date information at the beginning of the day, may update the information with any intraday transaction processing, and may update the information with closing data at the end of the day. In one embodiment, mortgage finance dashboard program or application 115 may automatically refresh the data according to preset time intervals.

In one embodiment, mortgage finance dashboard program or application 115 may load or receive information from, for example, a customer-facing website (e.g., Mortgage Finance Online), ProMerit and Helper databases, etc.

In one embodiment, mortgage finance dashboard program or application 115 may perform a data integrity check, wherein mortgage finance dashboard program or application 115 may check whether the information loaded or received is of the proper type and format. In one embodiment, bad-formatted data may be rejected by mortgage finance dashboard program or application 115. An alert may then be generated, and a notification may be sent to one or more persons responsible for reviewing the bad-formatted data.

In another embodiment, mortgage finance dashboard program or application 115 may accept bad-formatted data and attempt to correct it prior to processing the data.

In another embodiment, bad-formatted data may be reported in a dashboard.

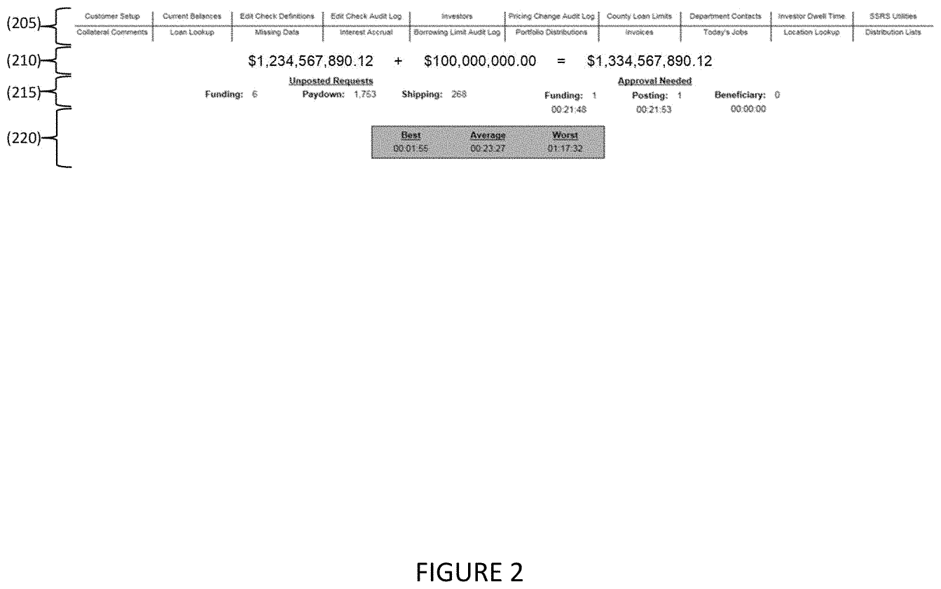

Mortgage finance dashboard program or application 115 may contain one or more graphical user interface elements as described and shown in FIGS. 2-6.

In another embodiment, mortgage finance dashboard program or application 115 may be executed by a server (not shown) or in the cloud (not shown) and may be accessed by a browser interface executed by computing device 110.

FIG. 2 depicts exemplary graphical user interface elements for an interactive mortgage dashboard according to an exemplary embodiment.

Referring to FIG. 2, the graphical user interface elements may be provided on a display on an electronic device. In one embodiment, the graphical user interface may be provided by a computer program or application provided by a financial institution.

Referring to FIG. 2, the interactive mortgage dashboard may include such information as: a toolbar of hyperlinks (205), a summary of the total outstanding balance amount of all active portfolios (210), a summary of accounts with unposted loan requests and accounts for which loan approval is needed (215), and a summary of the speed at which loans have been funded in a certain time period (220).

In one embodiment, the hyperlinks (205) may be to specific sections of the mortgage finance dashboard.

In one embodiment, the summary of the speed at which loans have been funded may include a fastest time (“best”), an average time, and a slowest time (“worst”). In one embodiment, the summary may be for a single day, i.e. the speed at which loans were funded for the current day. In another embodiment, the summary may be for a longer or shorter period of time.

In one embodiment, the summary of the speed at which loans have been funded in a certain time period (220) may generate an alert if the time to fund a loan exceeds a predetermined threshold. For example, if a loan takes longer than an hour to fund, the summary box 220 may turn red. In one embodiment, the alert may require a user to enter a justification for why the funding took longer than the threshold time. If no justification is entered, an email may be systematically sent alerting the manager(s) of the missing justification. The manager(s) may then update and certify any loan beyond the one-hour period.

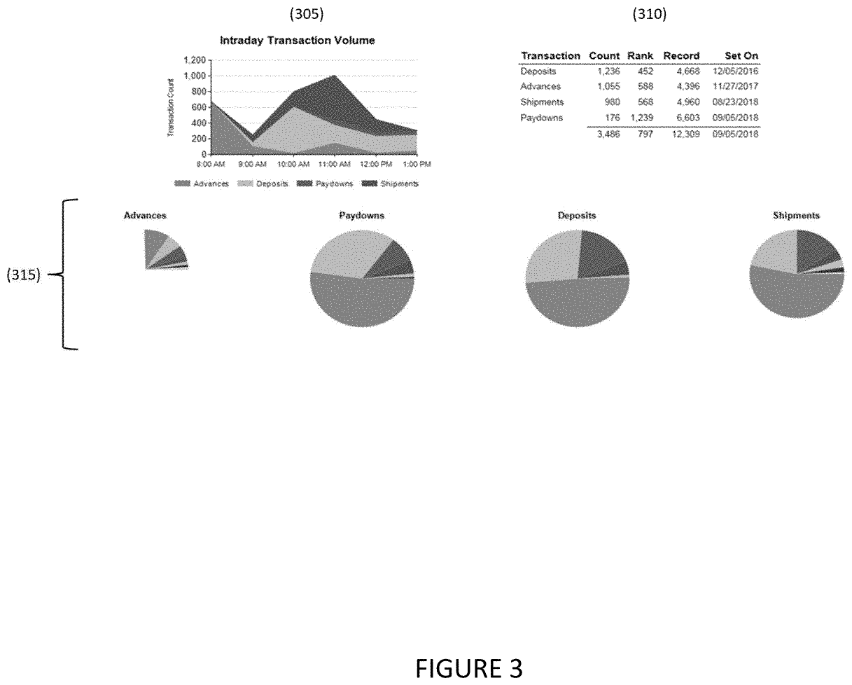

FIG. 3 depicts exemplary graphical user interface elements for an interactive mortgage dashboard according to an exemplary embodiment.

Referring to FIG. 3, the graphical user interface elements may be provided on a display on an electronic device. In one embodiment, the graphical user interface may be provided by a computer program or application provided by a financial institution.

Referring to FIG. 3, the interactive mortgage dashboard may include such information as: a chart of transaction volume (305), a table of transaction volume (310), and one or more charts depicting the relative impact of various accounts on the day's transaction volume (315). The divisions in the charts depicted in FIG. 3 represent, for example, different Warehouse Finance Operations employees.

In one embodiment, the chart of transaction volume 305 may be intraday, i.e. for a single day. In another embodiment the chart may display data for a longer or a shorter period of time. The chart of transaction volume 305 may be a bar chart, a scatter plot, an area chart, a line chart, or any other suitable chart for displaying transaction volumes.

In one embodiment, the table of transaction volume (310) may include a count of total transactions over a period of time, for example for a single day. The table may also display how a count of transactions for a particular period of time compares to historical data. The table may include, for example, a “rank” column that displays the rank of a time period's transaction volume as compared with historical data (e.g., where “1” represents a the highest, “2” the second highest, etc.).

In one embodiment, the table of transaction volume (310) may include historical data, such as the highest amount of transactions recorded in a comparable period and the date on which such record was set.

In one embodiment, the charts depicting the relative impact of various accounts on the day's transaction volume (315) may be pie charts. There may be pie charts specifically for advances, paydowns, deposits, shipments, advance jobs, paydown jobs, pre-funding docs, and/or shipment jobs. Advances and paydowns are draws and repayments of a revolving credit line. A deposit is receipt of a note. A shipment is a release of a note to an investor.

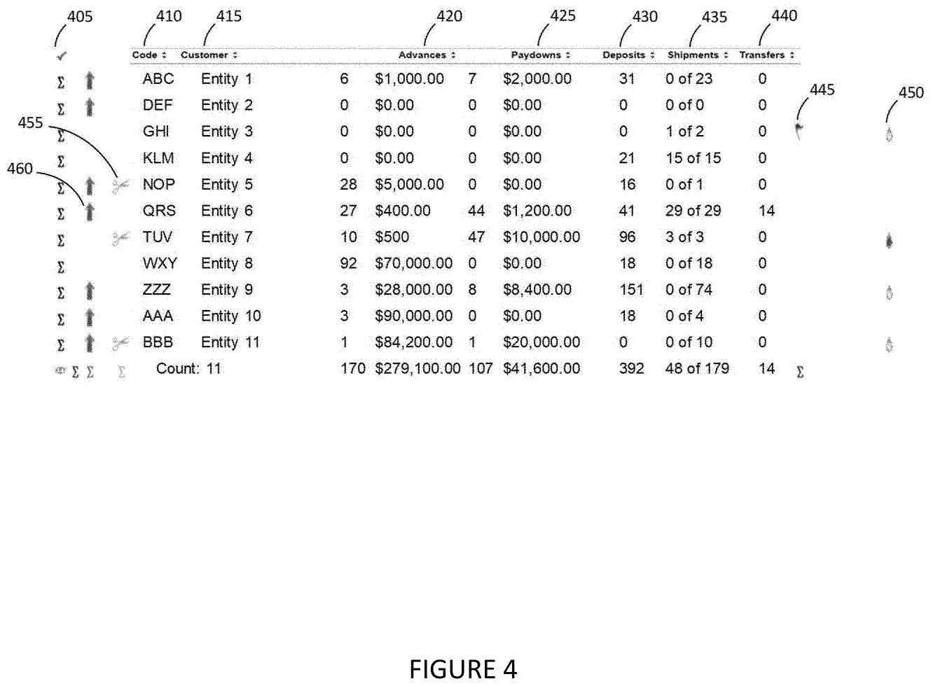

FIG. 4 depicts exemplary graphical user interface elements for an interactive mortgage dashboard according to an exemplary embodiment. The graphical user interface may be provided by a computer program or application provided by a financial institution.

The interactive mortgage dashboard may include a table of all accounts. The table may include such column information as, for example: a customer code (410), a customer name (415), the number of advances for the account and the total value of those advances (420), the number of paydowns for the account and the total value of those paydowns (425), the number of deposits for the account (430), the number of shipments for the account (435), the number of transfers for the account (440), and various status icons indicating a status of the account and recommended actions (445, 450, 455, 460).

In one embodiment, the state of each account may be indicated by, for example, the color of its text. For example, different colors or fonts may be used to indicate that opening balances have not been imported, that the funding account is in balance, that the funding account is out of balance, that the funding account is negative, that the operating account is negative, that the finding and operating accounts are both negative, that the manager has affirmed account reconciliation, etc. Different colors, fonts, enhancements, etc. may be used to represent these and/or other statuses as is necessary and/or desired.

In one embodiment, the shipments column (435) may include the number of shipments completed and the number of shipments expected in total.

In one embodiment, the status icons may include a flag (445), which may indicate different statuses, such as a transfer to age or aging sublimit, a transfer to a corresponding sublimit within the financial institution, a financial institution loan that shifts to an investor outside the financial institution, a loan that requires a fraud review that has been posted in, for example, ProMerit without a required fraud review, etc. Different flags, flag colors, icons, etc. may be used as is necessary and/or desired.

In one embodiment, the status icons may include an indicator, such as water droplet (450), which may indicate that a loan is wet or dry. In one embodiment, a blue water drop may indicate that collateral notes have not be received for a funded loan yet. In another embodiment, a blue water drop may not appear until a certain amount of time has passed after funding a loan.

In one embodiment, the status icons may include a red water droplet. A red water droplet may indicate that a client has insufficient funds in their operating account for processing of the wet haircut.

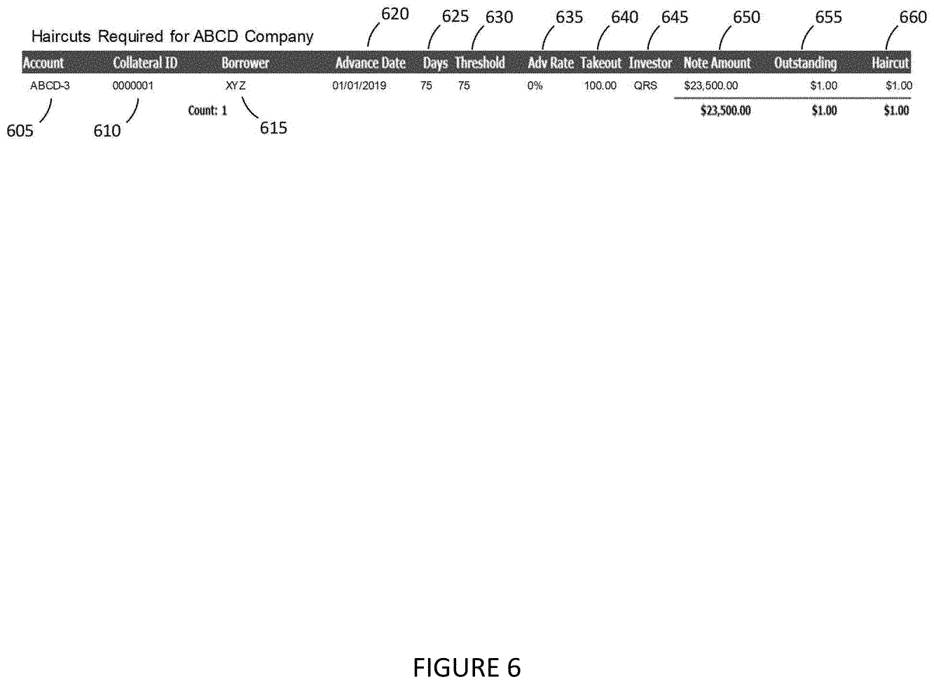

In one embodiment, the status icons may include an indicator, such as scissors icon (455), which may indicate that the loan meets the qualifications for a “haircut” as described above with respect to FIG. 1. In one embodiment, the scissors icon may be a hyperlink to a more detailed “haircut” view, for example the view shown in FIG. 6, wherein action may be taken with the account (such as executing a “haircut”).

In one embodiment, the status icons may include an indicator, such as arrow icon (460), that may indicate that the account is not funded to maximum capacity.

The status icons described herein (e.g., arrows, flags, scissors, water droplets) are exemplary, and one of skill in the art may readily appreciate that other icons, graphics, colors, or indicators may be used to convey similar information about an account.

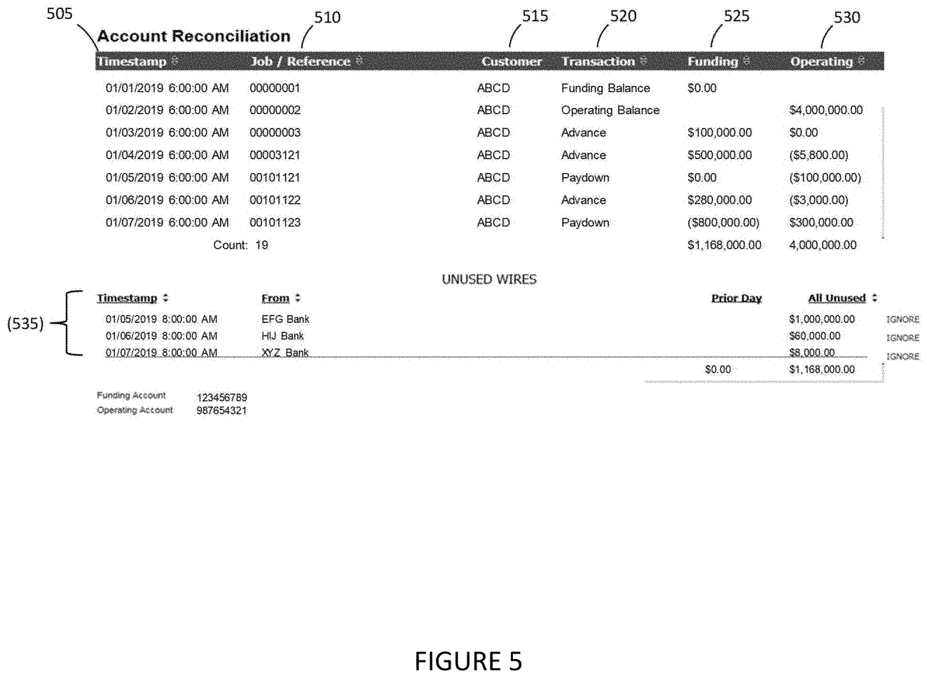

In one embodiment, the table of accounts may also include a hyperlink to an account reconciliation page (405) (for example, a page as shown in FIG. 5), wherein detailed account information may be displayed. In one embodiment, the hyperlink may be a capital sigma icon.

In one embodiment, a mortgage finance dashboard application may require that a user affirm that each account is in balance at the end of each day. For example, a user may be required to click an icon, such as the sigma icon, for each account to verify and affirm that the account is in balance. If a user does not affirm that each account is in balance, a message (e.g., an email, a SMS message, a push notification, etc.) may be sent out at or near close of business of the day, or at any other desired time, to notify that the affirmation has not been completed.

FIG. 5 depicts exemplary account reconciliation graphical user interface for an interactive mortgage dashboard according to an exemplary embodiment. The graphical user interface may be provided on a display on an electronic device. In one embodiment, the graphical user interface may be provided by a computer program or application provided by a financial institution.

The interface depicted in FIG. 5 may be the destination of a hyperlink in mortgage finance dashboard, for example as shown in FIG. 4 and described in its accompanying text.

In one embodiment, the account reconciliation graphical user interface may be for a single account and may include all transactions on record for that account. The table may include such column information as: timestamp information for each transaction (505), internal reference numbers for each transaction (510), a customer identifier (515), a transaction classification (520), a funding amount for each transaction (525), and an operating amount for each transaction (530).

In one embodiment, a mortgage finance dashboard application may include an autopilot function, wherein advances are processed automatically. For example, the advance request may be processed through a straight through processing to wire the payments to the title company. In one embodiment, the autopilot function may pause if there is not enough money in the account.

In one embodiment, the table in FIG. 5 may include a row for summations of each numeric column.

The table may also include a summary of information on unused wires (535). “Unused wires” refers to money not yet used to pay of a loan. The summary of unused wires information may include a timestamp column, a “from” column for what entity sent the wire, and a dollar amount column.

In one embodiment, the mortgage finance dashboard may include a button to ignore one or more unused wires.

FIG. 6 depicts exemplary “haircut” graphical user interface for an interactive mortgage dashboard according to an exemplary embodiment. The graphical user interface may be provided on a display on an electronic device. In one embodiment, the graphical user interface may be provided by a computer program or application provided by a financial institution.

The interface depicted in FIG. 6 may be the destination of a hyperlink in mortgage finance dashboard, for example as shown in FIG. 4 and described in its accompanying text.

Referring to FIG. 6, the “haircut” graphical user interface may display details about a recommended “haircut” for a particular account. The table may include such column information as: an account identifier (605), a collateral identifier (e.g., a loan identifier) (610), a borrower identifier (615), an advance date for the loan (620), a counter for the number of days since the advance date (625), a threshold number of days for the account (630), an advance rate (635), a takeout (e.g., an investor purchase price expressed as a percentage of an amount) (640), an investor identifier (645), a note amount (650), an outstanding amount (655), and a recommended haircut amount (660).

In one embodiment, when a loan reaches a certain day it may require a curtailment or a “haircut.” For example, there may be a threshold day set for a loan (630). When that threshold is passed, a “haircut” may be recommended. In such a case, the mortgage finance dashboard may display an icon, for example a scissors icon, next to an account (for example as shown in FIG. 4). The scissors icon may provide a hyperlink to the interface shown in FIG. 6. From the interface shown in FIG. 6, a user may review the loan details and trigger a “haircut” for the loan.

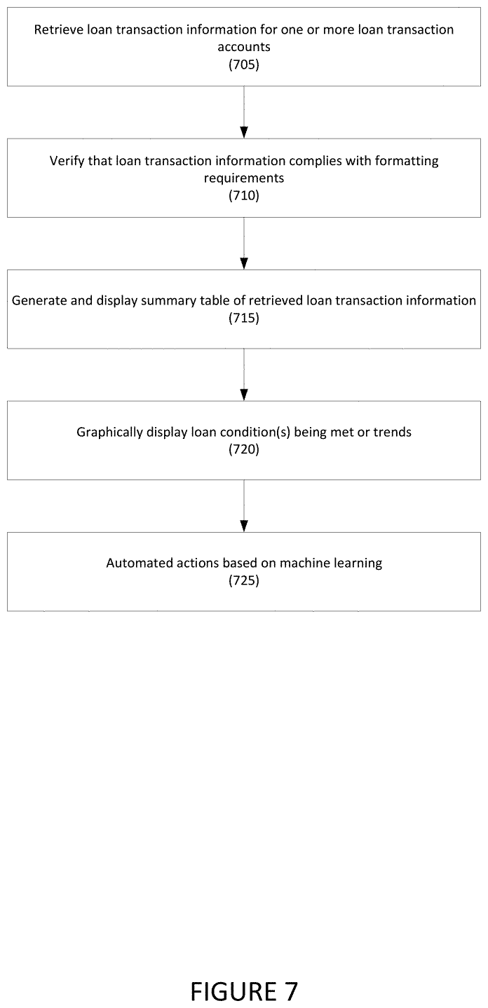

FIG. 7 depicts a method for providing a mortgage finance dashboard is disclosed according to an exemplary embodiment.

In step 705, a mortgage finance dashboard application executing on an information processing apparatus comprising at least one computer processor may retrieve loan transaction information for one or more loan transaction accounts.

In one embodiment, machine learning may be used to identify he loan transaction accounts that are to be displayed on the dashboard. In another embodiment, the identification of the loan transaction accounts may be automated based accounts that may need an action to be taken.

In step 710, the mortgage finance dashboard application may verify that the retrieved loan transaction information complies with predetermined formatting requirements.

In one embodiment, the mortgage finance dashboard application may reject the loan transaction information if it does not comply with the formatting requirements. For example, the mortgage finance dashboard application may send a notification or alert to the loan transaction information source indicating the noncompliance with the formatting requirements.

In one embodiment, the mortgage finance dashboard application may attempt to automatically correct the formatting of the loan transaction information. In one embodiment, machine learning may be used to correct the formatting of the loan transaction information.

In step 715, the mortgage finance dashboard application may display a summary table of the retrieved loan transaction information, the summary table comprising one or more of customer names, advances, paydowns, deposits, shipments, and transfers for each customer. In one embodiment, the order in which the loans are displayed may be based on actions required, age, user preferences based on machine learning, etc.

In step 720, the mortgage finance dashboard application may display a graphical indication that a loan condition is met, that action is required, etc. In one embodiment, the graphical indication may be in icon (e.g., scissors, rain drop, etc.), colors (e.g., red or blue), etc. In one embodiment, the graphical indication may be associated with an action, such as contacting the party by email, in-app communication, SMS messaging, phone, mail, etc.

In one embodiment, at least some of the graphical indications may be suppressed based on machine learning from historical data.

In one embodiment, machine learning and/or artificial intelligence may be used to identify trends that may also be graphically identified in the mortgage finance dashboard. For example, trends or patterns in funding requests, in spending, borrowing, etc. may be identified, and appropriate actions may be taken based on the trends. In one embodiment, the mortgage finance dashboard application may forecast.

In one embodiment, the graphical indications may recommend an action to be taken, such as a haircut, recalculate a loan that is overfunded, etc.

In step 725, the mortgage finance dashboard application may automatically execute an action. In one embodiment, machine learning based on historical data may be used to identify actions that may be automatically taken.

One of ordinary skill in the art will readily appreciate that the embodiments described provide numerous advantages over existing technology. For example, by automatically compiling up-to-date data in a succinct form in a single UI, a finance manager may be able to approve account balances much faster than if he or she were to have to gather all the information him or herself.

Hereinafter, general aspects of implementation of the systems and methods of the embodiments will be described.

The system of the embodiments or portions of the system of the embodiments may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

What is claimed is:

1. A computer-implemented method for providing a mortgage finance dashboard, comprising:
in an information processing apparatus comprising at least one computer processor:
retrieving loan transaction information for a plurality of loan accounts;
verifying that the loan transaction information complies with predetermined formatting requirements;
generating and displaying a summary table of the retrieved loan transaction information on a display, the summary table comprising one or more of customer names, advances, paydowns, deposits, shipments, and transfers for each loan account;
identifying a loan condition or trend associated with at least one of the loan accounts;
identifying a recommendation for the at least one of the loan accounts based on the loan condition or trend;
associating a graphical indicator with the loan condition or trend;
displaying the graphical indicator on the display with the recommendation; and
automatically executing the recommendation.

2. The method of claim 1, wherein the recommendation is a haircut.

3. The method of claim 1, wherein the recommendation is to recalculate a loan.

4. The method of claim 1, wherein the recommendation is to contact the loan account holder.

5. The method of claim 1, further comprising:
automatically re-formatting the loan transaction information to comply with the predetermined formatting requirements.

6. The method of claim 1, wherein the loan condition or trend associated with the at least one of the loan accounts is identified based on historical loan information for the at least one of the loan accounts.

7. The method of claim 1, wherein the loan condition or trend associated with the at least one of the loan accounts is identified using machine learning.

8. The method of claim 1, wherein the graphical indicator comprises an icon.

9. The method of claim 8, wherein the icon comprises a color.

10. The method of claim 1, wherein the recommendation is automatically executed in response to a selection of the graphical indicator.

11. A system for providing a mortgage finance dashboard, comprising:
an electronic device comprising at least one computer processor and executing a mortgage finance dashboard computer program;
a plurality of internal data sources storing internal loan information for a plurality of customers;
a plurality of third-party data sources storing external loan information for at least some of the plurality of customers;
wherein:
the mortgage finance dashboard computer program retrieves loan transaction information for a plurality of loan accounts from the internal data sources and the external data sources;
the mortgage finance dashboard computer program verifies that the loan transaction information complies with predetermined formatting requirements;
the mortgage finance dashboard computer program generates and displays a summary table of the retrieved loan transaction information on a display, the summary table comprising one or more of customer names, advances, paydowns, deposits, shipments, and transfers for each loan account;
the mortgage finance dashboard computer program identifies a loan condition or trend associated with at least one of the loan accounts;
the mortgage finance dashboard computer program identifies a recommendation for the at least one of the loan accounts based on the loan condition or trend;
the mortgage finance dashboard computer program associates a graphical indicator with the loan condition or trend;
the mortgage finance dashboard computer program displays the graphical indicator on the display with the recommendation; and
the mortgage finance dashboard computer program automatically executes the recommendation.

12. The system of claim 11, wherein the recommendation is a haircut.

13. The system of claim 11, wherein the recommendation is to recalculate a loan.

14. The system of claim 11, wherein the recommendation is to contact the loan account holder.

15. The system of claim 11, wherein the mortgage finance dashboard computer program automatically re-formats the loan transaction information to comply with the predetermined formatting requirements.

16. The system of claim 11, wherein the loan condition or trend associated with the at least one of the loan accounts is identified based on historical loan information for the at least one of the loan accounts.

17. The system of claim 11, wherein the loan condition or trend associated with the at least one of the loan accounts is identified using machine learning.

18. The system of claim 11, wherein the graphical indicator comprises an icon.

19. The system of claim 18, wherein the icon comprises a color.

20. The system of claim 11, wherein the recommendation is automatically executed in response to a selection of the graphical indicator.
